(19) United States
(12) Patent Application Publication
(10) Pub. No.: US 2026/0282132 A1
(43) Pub. Date: Sep. 17, 2026

(54) ULTRA-WIDE-BANDWIDTH TRANSMISSION MECHANISM IN WIRELESS COMMUNICATIONS

(71) Applicant: MEDIATEK INC., Hsinchu City (TW)

(72) Inventors: Kai Ying LU, San Jose, CA (US); Kuo-Wei CHEN, Hsinchu City (TW); Hung-Tao HSIEH, Hsinchu City (TW); Cheng-Yi CHANG, Hsinchu City (TW); Chien-Fang HSU, Hsinchu City (TW); James Chih-Shi YEE, San Jose, CA (US); Yi-Hsiang LAI, Hsinchu City (TW)

(21) Appl. No.: 19/168,279

(22) PCT Filed: Nov. 12, 2024
(86) PCT No.: PCT/CN2024/131536

§ 371 Date: Sep. 23, 2025

Related U.S. Application Data
(60) Provisional application No. 63/598,165, filed on Nov. 13, 2023.

(51) Int. Cl. H04W 76/15

(52) U.S. Cl. CPC H04W 76/15

(57) ABSTRACT

Techniques pertaining to an ultra-wide-bandwidth (UWB) transmission mechanism in wireless communications are described. An apparatus (e.g., access point (AP)) establishes a basic service set (BSS) on a primary link and an auxiliary link. The apparatus then performs an aggregated-bandwidth operation with one or more stations (STAs). An aggregated bandwidth of the primary link and the auxiliary link depends on a channel availability of each of the primary link and the auxiliary link.

### CROSS REFERENCE TO RELATED PATENT APPLICATION

The present disclosure is part of a non-provisional patent application claiming the priority benefit of U.S. Provisional Patent Application No. 63/598,165, filed 13 Nov. 2023, the content of which herein is incorporated by reference in its entirety.

### TECHNICAL FIELD

The present disclosure is generally related to wireless communications and, more particularly, to an ultra-wide-bandwidth (UWB) transmission mechanism in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and wireless local area networks (WLANs) under the Institute of Electrical and Electronics Engineers (IEEE) 802.11 standards, the maximum channel bandwidth at the present time is 320 MHz (e.g., Max 320 MHz) due to channelization limitation. Under a multi-link operation scheme, multi-link devices (MLDs) with multiple radios are allowed to simultaneously transmit and receive (STR) on multiple links, so that the total effective bandwidth can be aggregated. However, the multi-link operation scheme requires a frequency gap between the multiple links used for transmission/reception to be sufficiently large so as to avoid in-device interference (IDC). Otherwise, a multi-link device may only operate on the multiple links in a non-simultaneous transmission and reception (NSTR) mode due to IDC. In such cases, the effective bandwidth cannot be aggregated under NSTR schemes. On the other hand, a single-radio device may also operate on multiple links, although it can only operate on one link at any time. Accordingly, the bandwidth is limited to the bandwidth of the one link used for transmission/reception since there is no aggregation bandwidth of two or more links. However, some devices may have higher radio frequency (RF) capacity with wider bandwidth than 320 MHz. As such, how to achieve an effective wider bandwidth in a single link for usage by a device with a RF capacity of 340 MHz, 360 MHz, 400 MHz or 480 MHz bandwidth or greater remains a challenge. Therefore, there is a need for a solution for a UWB transmission mechanism in wireless communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to a UWB transmission mechanism in wireless communications. It is believed that implementation of one or more schemes proposed herein may address or otherwise alleviate the aforementioned issue(s).

In one aspect, a method may involve an access point (AP) establishing a basic service set (BSS) on a primary link and an auxiliary link. The method may also involve the AP performing an aggregated-bandwidth operation with one or more stations (STAs), with an aggregated bandwidth of the primary link and the auxiliary link depending on a channel availability of the primary link and the auxiliary link. The primary link and the auxiliary link may use one single RF or separate RFs depending on an RF capacity of the AP.

In another aspect, a method may involve a non-AP STA receiving a beacon frame or management frame indicating an aggregated-bandwidth capability of an AP. The method may also involve the non-AP STA performing an aggregated-bandwidth operation involving a primary link and an auxiliary link with the AP, with an aggregated bandwidth of the primary link and the auxiliary link depending on a channel availability of the primary link and the auxiliary link. The primary link and the auxiliary link may use one single RF or separate RFs depending on an RF capacity of the AP.

It is noteworthy that, although the description provided herein may be in the context of certain radio access technologies, networks and network topologies such as Wi-Fi/WiFi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example scenario under a proposed scheme in accordance with the present disclosure.

FIG. 4 is a block diagram of an example communication system under a proposed scheme in accordance with the present disclosure.

FIG. 5 is a flowchart of an example process under a proposed scheme in accordance with the present disclosure.

FIG. 6 is a flowchart of a second example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a UWB transmission mechanism in wireless communications. According to the present disclosure, a number of possible solutions may be implemented separately or jointly. That is, although these possible solutions may be described below separately, two or more of these possible solutions may be implemented in one combination or another. The various solutions and schemes implement the proposed schemes between APs and non-AP STAs. Accordingly, the various solutions and schemes proposed herein may address or otherwise alleviate the issues described above.

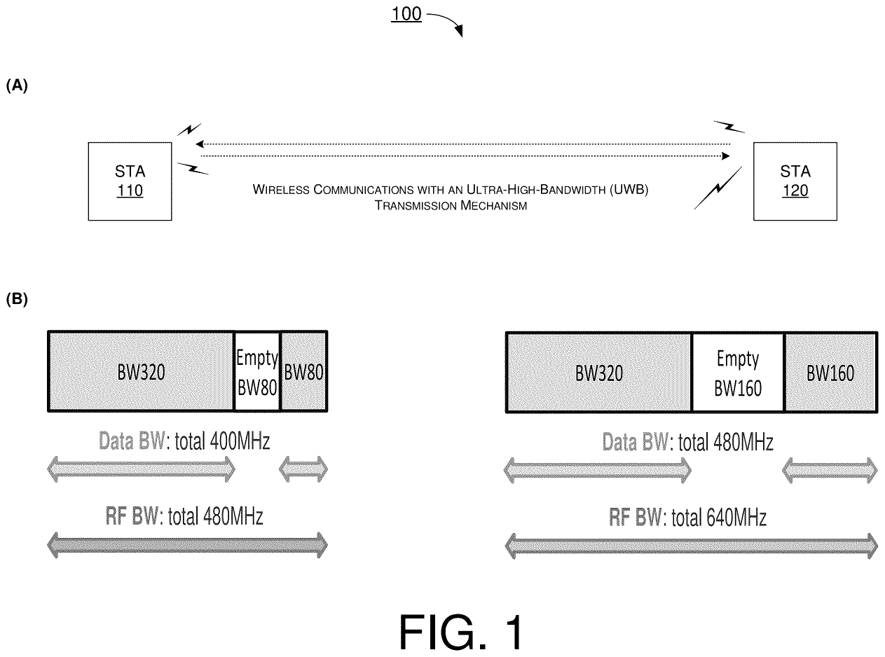

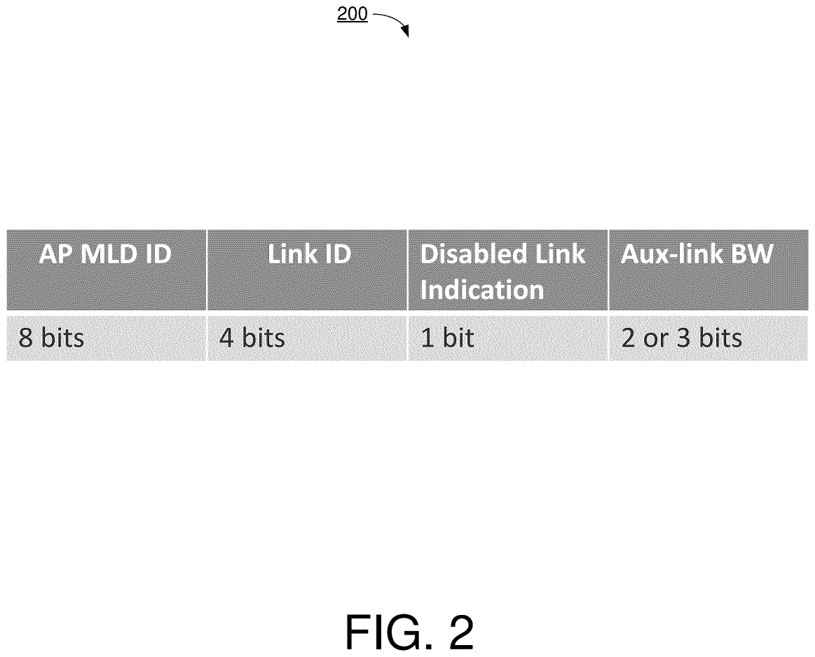

FIG. 1 illustrates an example network environment 100 in which various solutions and schemes in accordance with the present disclosure may be implemented. FIG. 2-FIG. 6 illustrate examples of implementation of various proposed schemes in network environment 100 in accordance with the present disclosure. The following description of various proposed schemes is provided with reference to FIG. 1-FIG. 6.

Referring to part (A) of FIG. 1, network environment 100 may include at least a first station (STA), or STA 110, and a second STA, or STA 120. One of STA 110 and STA 120 may be an access point (AP) STA (herein interchangeably referred to as “AP”) and the other of STA 110 and STA 120 may be a non-AP STA (herein interchangeably referred to as “STA”) associated with the AP STA. STA 110 and STA 120 may be part of a basic service set (BSS). While there may be additional STAs involved in network environment 100 under one or more schemes proposed herein, for simplicity only two STAs (STA 110 and STA 120) are shown in FIG. 1 with the understanding that additional STAs may be involved. Each of STA 110 and STA 120 may be configured to implement various proposed schemes in accordance with the present disclosure as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Referring to part (B) of FIG. 1, under the various proposed schemes, a next-generation system may allow an AP to determine to support an aggregated bandwidth such as, for example, 320+20 MHz, 320+40 MHz, 320+80 MHz, 320+160 MHz or 320+320 MHz using one single radio. Accordingly, an AP (e.g., STA 110) with a higher RF capacity may aggregate two or more adjacent channels based on channelization, as shown in part (B) of FIG. 1. As an example, when the AP has an RF capacity of 480 MHz, the AP may support and/or operate in an aggregated bandwidth of 320+80 MHz (or a total of 400 MHz). As another example, when the AP has a RF capacity of 640 MHz, the AP may support and/or operate in an aggregated bandwidth of 320+160 MHz (or a total of 480 MHz). The AP may perform channel access on the two or more adjacent channels following enhanced distributed channel access (EDCA) rules for channel access with some restrictions. Each associated non-AP STA (e.g., STA 120) may only perform channel access on the primary channel. It may not need to support bandwidth aggregation but may support dynamic channel switching within the aggregated bandwidth.

Under a proposed scheme in accordance with the present disclosure, regarding advertising in an aggregated-bandwidth operation, an AP (e.g., STA 110) with an aggregated-bandwidth capability may set up or otherwise establish a BSS on a primary link and an auxiliary link. For instance, the primary link may be with a bandwidth of 20 MHz, 40 MHz, 80 MHz, 160 MHz or 320 MHz, and the auxiliary link may be with a bandwidth of 20 MHz, 40 MHz, 80 MHz, 160 MHz or 320 MHz. The total bandwidth of the primary and auxiliary links may depend on the RF bandwidth of the AP. Both the primary and auxiliary links may belong to the same BSS with continuous channels (that is, contiguous channels in the frequency domain) or non-continuous channels on the primary link and the auxiliary link. The aggregated-bandwidth capable AP may be affiliated with an AP MLD, and the link identification (ID) of each of the primary link and auxiliary link may be the same or otherwise identical.

Under the proposed scheme, the AP may transmit one or more Beacon frames and other Management frames such as, for example, Probe response frames and/or association response frames, on the primary link. The AP may indicate its aggregated-bandwidth capability and/or information of the aggregated bandwidth in an Ultra-High-Reliability (UHR) Operation element or UHR Capability element carried in the Beacon/Probe response/association response frames on the primary link. Additionally, the AP may not transmit Beacon frames or other Management frames (e.g., Probe response frames and/or association response frames) on the auxiliary link.

Under the proposed scheme, each Beacon frame or Management frame may advertise the auxiliary link using a Reduced Neighbor Report (RNR) element with a Target Beacon Transmission Time (TBTT) Information Field Type subfield set to one predefined value (e.g., 1) and a TBTT Information Field Length subfield set to another predefined value (e.g., 3) in a TBTT Information field corresponding to the reported AP (which may be the reporting AP itself) on the auxiliary link. The TBTT Information field corresponding to the reported AP on the auxiliary link may include at least one of the following subfields: link ID, link disablement, and aggregation bandwidth.

The link disablement subfield may indicate whether the auxiliary link is enabled or disabled. When the link disablement subfield indicates “enabled”, the aggregated bandwidth may be indicated in the TBTT Information field, meaning that the reporting AP is operating with an aggregated bandwidth. When the link disablement subfield indicates “disabled”, the aggregated bandwidth subfield may be reserved in the TBTT Information field, meaning that the reporting AP is not operating with any aggregated bandwidth. Moreover, the channel number of the auxiliary link may be indicated in the Neighbor AP field corresponding to the reported AP on the auxiliary link in the RNR element.

FIG. 2 illustrates an example design 200 under a proposed scheme in accordance with the present disclosure. When a reporting AP is affiliated with an AP MLD, the reporting AP may advertise the primary link and auxiliary link of its aggregated-bandwidth capable neighbor AP affiliated with the same AP MLD, as the reported AP. The reporting AP may advertise the primary link of the reported AP with the TBTT Information Field Type set to one predefined value (e.g., 0) and the auxiliary link of the same reported AP with the TBTT Information Field Type set to another predefined value (e.g., 1) in its RNR element. The link ID corresponding to each of the primary link and auxiliary link may be set to a same value. FIG. 2 shows a format of the TBTT Information Field under design 200.

Under a proposed scheme in accordance with the present disclosure, regarding discovery and association in an aggregated-bandwidth operation, a non-AP STA (e.g., STA 120) may identify the aggregated-bandwidth capable AP (e.g., STA 110) by the aggregated bandwidth capability indication in the UHR Operation element or UHR Capability element carried in the Beacon/probe response frame. Alternatively, the non-AP STA may discover the auxiliary link of the aggregated-bandwidth capable AP by RNR element with TBTT Information Field Type subfield equal to 1 and TBTT Information Field length subfield equal to 1 or 3. The channel number of the auxiliary link may be determined in the Neighbor AP field corresponding to the reported AP on the auxiliary link in the RNR element. Any non-AP STA may be associated with an aggregated bandwidth capable AP on the primary link of the BSS.

Under the proposed scheme, a non-AP STA capable of identifying an auxiliary link may not transmit any probe request or association request frames on the auxiliary link. The non-AP STA may indicate to the aggregated-bandwidth capable AP whether the non-AP STA is capable of dynamic channel switching within a specific bandwidth. For instance, the non-AP STA may indicate to the aggregated-bandwidth capable AP that it is capable of dynamic channel switching within an 80 MHz, 160 MHz, 320 MHz, 340 MHz, 360 MHz, 400 MHz, 480 MHz or 640 MHz bandwidth. The specific bandwidth may be less than or equal to the aggregated bandwidth of the AP.

Under the proposed scheme, a non-AP STA may discover the auxiliary link of an aggregated-bandwidth capable AP based on the RNR element with TBTT Type subfield being equal to 1 and the TBTT Information Length subfield being equal to 1 or 3. The non-AP STA may be affiliated with a single link, single-radio or multi-radio multi-link device. In an event that the non-AP STA is affiliated with a single-link device or a single-radio multi-link device, the non-AP STA may identify an aggregated-bandwidth capable reporting AP by the aggregated bandwidth capability indicated in the UHR Operation element or UHR Capability element carried in the Beacon/probe response frame. The non-AP STA may further identify the auxiliary link disablement status and aggregation bandwidth of the reporting AP by the RNR element.

In an event that the non-AP STA is affiliated with a multi-radio multi-link device, the non-AP STA may also identify a reported AP which is aggregated-bandwidth capable by the RNR element carried in the Beacon/probe response frame, which may include another neighbor AP with the TBTT Information Field Type subfield set to one predefined value (e.g., 1), the TBTT Information Length subfield set to another predefined value (e.g., 1 or 3), and with the same or otherwise identical link ID of the reported AP. The non-AP STA may further identify the link disablement status of the auxiliary link and the aggregation bandwidth of the reported AP by the RNR element.

The channel number of the auxiliary link may be determined as the primary channel of the auxiliary link of the aggregated-bandwidth capable AP by the Neighbor AP Information field in the RNR element.

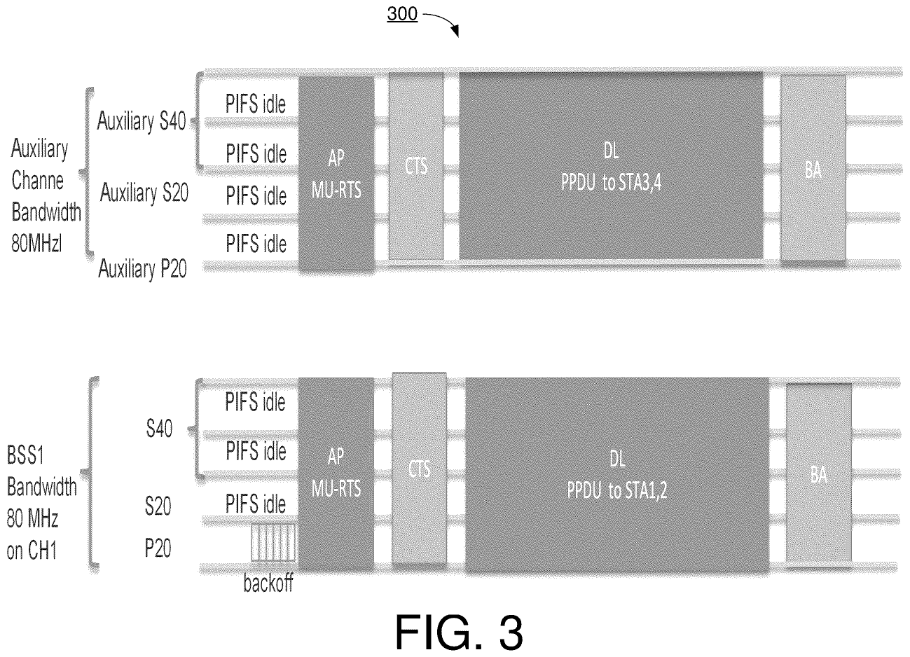

FIG. 3 illustrates an example scenario 300 under a proposed scheme in accordance with the present disclosure. Scenario 300 may pertain to a transmission over an aggregated bandwidth under the proposed scheme. Referring to FIG. 3, an AP (e.g., STA 110) may set up or otherwise establish a BSS with an operating bandwidth on 80 MHz on channel 1 (CH1), which may be the primary link of the AP and with an operating bandwidth of 80 MHz on channel 2 (CH2), which may be the auxiliary link of the AP. The AP may indicate its auxiliary link operation capability in its UHR Capability element or UHR Operating element. Additionally, the AP may include an RNR element advertising its auxiliary link on CH2. The AP may perform an EDCA backoff on the primary 20 MHz channel of the primary link and perform a point coordination function (PCF) interframe space (PIFS) idle detection on non-primary channels over the primary and auxiliary links. The AP may obtain a transmission opportunity (TXOP) and transmit an initial control frame (e.g., trigger frame) to STA1,2,3,4 (e.g., one of which being STA 120) and indicate to switch STA3,4 to the auxiliary link. Correspondingly, STA1,2 may respond with an initial control response frame on the primary link, and STA3,4 may switch to the auxiliary link and respond with an initial control response frame on the auxiliary link. The AP may then transmit a downlink (DL) data physical-layer protocol data unit (PPDU) or a trigger frame for soliciting uplink (UL) trigger based PPDU to STA1,2 over the primary link and to STA3,4 over the auxiliary link. Furthermore, STA3,4 may switch back to the primary link at the end of the TXOP.

### Illustrative Implementations

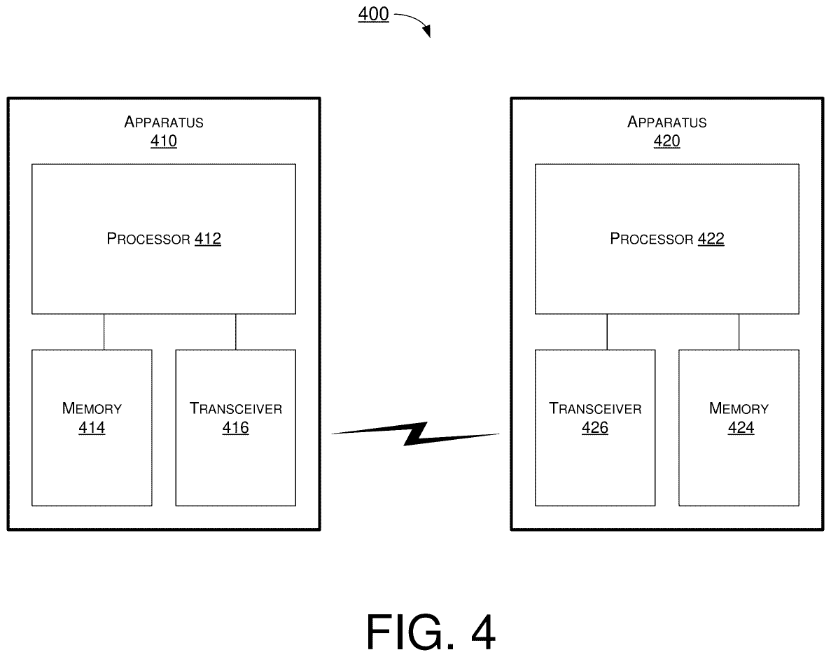

FIG. 4 illustrates an example system 400 having at least an example apparatus 410 and an example apparatus 420 in accordance with an implementation of the present disclosure. Each of apparatus 410 and apparatus 420 may perform various functions to implement schemes, techniques, processes, and methods described herein pertaining to a UWB transmission mechanism in wireless communications, including the various schemes described above with respect to various proposed designs, concepts, schemes, systems and methods described above as well as processes described below. For instance, apparatus 410 may be implemented in an AP STA (e.g., STA 110) and apparatus 420 may be implemented in a non-AP STA (e.g., STA 120), or vice versa.

Each of apparatus 410 and apparatus 420 may be a part of an electronic apparatus, such as a portable or mobile apparatus, a wearable apparatus, a wireless communication apparatus or a computing apparatus. When implemented in a STA, each of apparatus 410 and apparatus 420 may be implemented in a smartphone, a smart watch, a personal digital assistant, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker, or a home control center. When implemented in or as a network apparatus, apparatus 410 and/or apparatus 420 may be implemented in a network node, such as an AP in a WLAN or a mesh device.

In some implementations, each of apparatus 410 and apparatus 420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 410 and apparatus 420 may be implemented in or as a STA or an AP. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, one or more RISC processors or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to a UWB transmission mechanism in wireless communications in accordance with various implementations of the present disclosure.

In some implementations, apparatus 410 may also include a transceiver 416 coupled to processor 412. Transceiver 416 may include a transmitter capable of wirelessly transmitting and a receiver capable of wirelessly receiving data. In some implementations, apparatus 420 may also include a transceiver 426 coupled to processor 422. Transceiver 426 may include a transmitter capable of wirelessly transmitting and a receiver capable of wirelessly receiving data. It is noteworthy that, although transceiver 416 and transceiver 426 are illustrated as being external to and separate from processor 412 and processor 422, respectively, in some implementations, transceiver 416 may be an integral part of processor 412 as a system on chip (SoC) and/or transceiver 426 may be an integral part of processor 422 as a SoC.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410 or apparatus 420, as an STA (e.g., STA 120) or an AP (e.g., STA 110), respectively, is provided below in the context of example processes 500 and 600. It is noteworthy that, although a detailed description of capabilities, functionalities and/or technical features of either of apparatus 410 and apparatus 420 is provided below, the same may be applied to the other of apparatus 410 and apparatus 420 although a detailed description thereof is not provided solely in the interest of brevity. It is also noteworthy that, although the example implementations described below are provided in the context of WLAN, the same may be implemented in other types of networks.

### Illustrative Processes

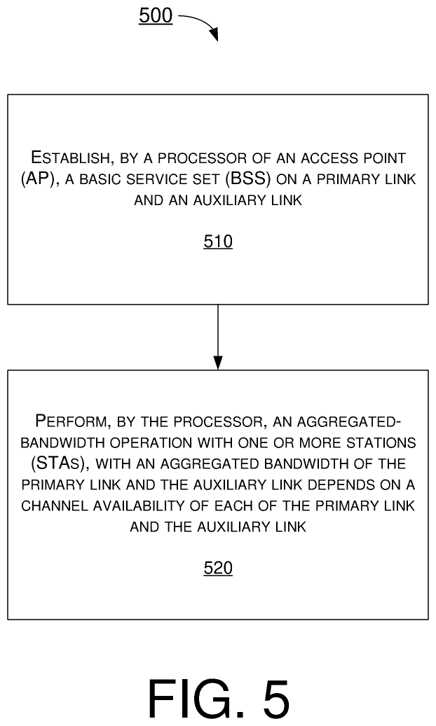

FIG. 5 illustrates an example process 500 in accordance with an implementation of the present disclosure. Process 500 may represent an aspect of implementing various proposed designs, concepts, schemes, systems, and methods described above. More specifically, process 500 may represent an aspect of the proposed concepts and schemes pertaining to a UWB transmission mechanism in wireless communications. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively, in a different order. Furthermore, one or more of the blocks/sub-blocks of process 500 may be executed repeatedly or iteratively. Process 500 may be implemented by or in apparatus 410 and apparatus 420 as well as any variations thereof. Solely for illustrative purposes and without limiting the scope, process 500 is described below in the context of apparatus 410 implemented in or as an AP STA (e.g., STA 110) and apparatus 420 implemented in or as a non-AP STA (e.g., STA 120) of a wireless network such as a WLAN in network environment 100 in accordance with one or more of IEEE 802.11 standards. Process 500 may begin at block 510.

At 510, process 500 may involve processor 412 of apparatus 410, as an AP STA (e.g., STA 110), establishing, via transceiver 416, a BSS on a primary link and an auxiliary link, with an aggregated bandwidth of the primary link and the auxiliary link depending on a channel availability of each of the primary link and the auxiliary link. The primary link and the auxiliary link may use one single RF or separate RFs depending on a RF capacity of the AP. Process 500 may proceed from 510 to 520.

At 520, process 500 may involve processor 412 performing, via transceiver 416, an aggregated-bandwidth operation with one or more STAs (e.g., including apparatus 420 as STA 120).

In some implementations, the AP may be affiliated with an AP MDL, and a link ID of the primary link and a link ID of the auxiliary link may be identical.

In some implementations, in performing the aggregated-bandwidth operation, process 500 may involve processor 412 transmitting a beacon frame or a management frame on the primary link but not the auxiliary link to indicate an aggregated-bandwidth capability of the AP and the aggregated bandwidth in an UHR Operation element or UHR Capability element carried in the beacon frame or management frame on the primary link.

In some implementations, the management frame may include a probe response frame or association response frame.

In some implementations, the beacon frame or management frame may advertise the auxiliary link using an RNR element with a TBTT Information Field Type subfield set to a first predefined value (e.g., 1) and a TBTT Information Field Length subfield set to a second predefined value (e.g., 1 or 3) in a TBTT Information field corresponding to a reported AP on the auxiliary link.

In some implementations, the TBTT Information field corresponding to the reported AP on the auxiliary link may include at least one of a link ID subfield, a link disablement subfield, and an aggregation bandwidth subfield.

In some implementations, the link disablement subfield may indicate whether the auxiliary link is enabled or disabled such that: (a) responsive to the link disablement subfield indicating the auxiliary link enabled, the aggregated bandwidth is indicated in the TBTT Information field to indicate that the AP is operating with the aggregated bandwidth; and (b) responsive to the link disablement subfield indicating the auxiliary link disabled, the aggregated bandwidth subfield is reserved in the TBTT Information field to indicate that the AP is not operating with the aggregated bandwidth.

In some implementations, a channel number of the auxiliary link may be indicated in a Neighbor AP field corresponding to the reported AP on the auxiliary link in the RNR element.

In some implementations, in performing the aggregated-bandwidth operation, process 500 may involve processor 412 advertising, as a reporting AP affiliated with an AP MLD, the primary link and the auxiliary link of an aggregated-bandwidth capable neighbor AP, as a reported AP, affiliated with the AP MLD.

In some implementations, in advertising, process 500 may involve processor 412 advertising the primary link with a TBTT Information Field Type subfield set to a first predefined value (e.g., 0) and a TBTT Information Field Length subfield set to a second predefined value (e.g., 1) in an RNR element.

In some implementations, in performing the aggregated-bandwidth operation with one or more STAs, process 500 may involve processor 412 certain operations. For instance, process 500 may involve processor 412 obtaining a TXOP. Additionally, process 500 may involve processor 412 transmitting a control frame to a first STA and a second STA of the one or more STAs with an indication to switch the second STA to the auxiliary link. Moreover, process 500 may involve processor 412 receiving a first control response frame from the first STA over the primary link and a second control response frame from the second STA over the auxiliary link. Moreover, process 500 may involve processor 412 transmitting a DL PPDU or a trigger frame to the first STA over the primary link and to the second STA over the auxiliary link.

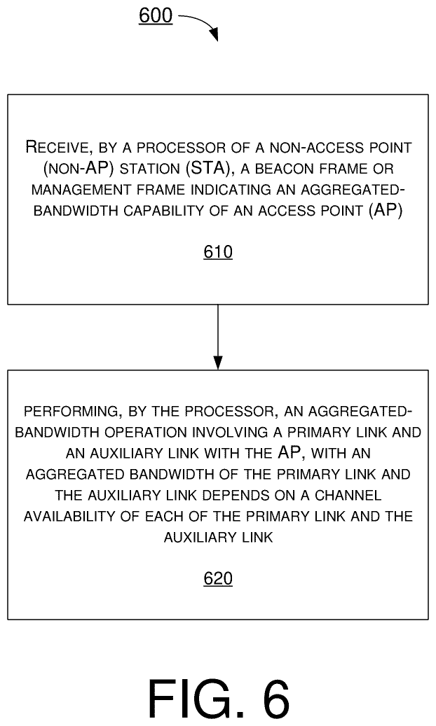

FIG. 6 illustrates an example process 600 in accordance with an implementation of the present disclosure. Process 600 may represent an aspect of implementing various proposed designs, concepts, schemes, systems, and methods described above. More specifically, process 600 may represent an aspect of the proposed concepts and schemes pertaining to a UWB transmission mechanism in wireless communications. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Furthermore, one or more of the blocks/sub-blocks of process 600 may be executed repeatedly or iteratively. Process 600 may be implemented by or in apparatus 410 and apparatus 420 as well as any variations thereof. Solely for illustrative purposes and without limiting the scope, process 600 is described below in the context of apparatus 410 implemented in or as an AP STA (e.g., STA 110) and apparatus 420 implemented in or as a non-AP STA (e.g., STA 120) of a wireless network such as a WLAN in network environment 100 in accordance with one or more of IEEE 802.11 standards. Process 600 may begin at block 610.

At 610, process 600 may involve processor 422 of apparatus 420, as a non-AP STA (e.g., STA 120), receiving, via transceiver 426, a beacon frame or management frame indicating an aggregated-bandwidth capability of an AP (e.g., apparatus 410). Process 600 may proceed from 610 to 620.

At 620, process 600 may involve processor 422 performing, via transceiver 426, an aggregated-bandwidth operation involving a primary link and an auxiliary link with the AP, with an aggregated bandwidth of the primary link and the auxiliary link depending on a channel availability of each of the primary link and the auxiliary link. The primary link and the auxiliary link may use one single RF or separate RFs depending on an RF capacity of the AP.

In some implementations, in performing the aggregated-bandwidth operation, process 600 may involve processor 422 discovering the auxiliary link based on an RNR element with a TBTT Information Field Type subfield set to a first predefined value (e.g., 1) and a TBTT Information Field Length subfield set to a second predefined value (e.g., 1 or 3) in a TBTT Information field.

In some implementations, a channel number of the auxiliary link may be indicated in a Neighbor AP field corresponding to the AP on the auxiliary link in the RNR element.

In some implementations, in performing the aggregated-bandwidth operation, process 600 may involve processor 422 indicating to the AP whether the STA is capable of dynamic channel switching within a specific bandwidth which is less than or equal to the aggregated bandwidth.

In some implementations, responsive to the non-AP STA being affiliated with a single-radio multi-link device, in performing the aggregated-bandwidth operation, process 600 may involve processor 422 identifying an aggregated-bandwidth capable reporting AP by an aggregated-bandwidth capability indicated in an UHR Operation element or UHR Capability element carried in the beacon frame or management frame. In some implementations, in performing the aggregated-bandwidth operation, process 600 may further involve processor 422 identifying a link disablement status of the auxiliary link and the aggregated bandwidth of the reporting AP based on an RNR element.

In some implementations, responsive to the non-AP STA being affiliated with a multi-radio multi-link device, in performing the aggregated-bandwidth operation, process 600 may involve processor 422 identifying a reported AP which is aggregated-bandwidth capable based on an RNR element carried in the beacon frame or management frame, which includes another neighbor AP with a TBTT Information Field Type subfield set to a first predefined value (e.g., 1) and a TBTT Information Field Length subfield set to a second predefined value (e.g., 1 or 3) with a same link ID of the reported AP. In some implementations, in performing the aggregated-bandwidth operation, process 600 may further involve processor 422 identifying a link disablement status of the auxiliary link and the aggregated bandwidth of the reported AP based on the RNR element.

In some implementations, in performing the aggregated-bandwidth operation with the AP, process 600 may involve processor 422 performing certain operations. For instance, process 600 may involve processor 422 receiving a control frame from the AP. Additionally, responsive to receiving the control frame, process 600 may involve processor 422 transmitting a control response frame to the AP over the primary link or, after switching to the auxiliary link, over the auxiliary link. Moreover, process 600 may involve processor 422 receiving a DL PPDU or a trigger frame over the primary link or the auxiliary link.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an access point (AP), a basic service set (BSS) on a primary link and an auxiliary link; and
performing, by the processor, an aggregated-bandwidth operation with one or more stations (STAs),
wherein an aggregated bandwidth of the primary link and the auxiliary link depends on a channel availability of each of the primary link and the auxiliary link.

2. The method of claim 1, wherein the AP is affiliated with an AP multi-link device (MLD), and wherein a link identification (ID) of the primary link and a link ID of the auxiliary link are identical.

3. The method of claim 1, wherein the performing of the aggregated-bandwidth operation comprises transmitting a beacon frame or a management frame on the primary link but not the auxiliary link to indicate an aggregated-bandwidth capability of the AP and the aggregated bandwidth in an Ultra-High-Reliability (UHR) Operation element or UHR Capability element carried in the beacon frame or management frame on the primary link.

4. The method of claim 3, wherein the management frame comprises a probe response frame or association response frame.

5. The method of claim 3, wherein the beacon frame or management frame advertises the auxiliary link using a Reduced Neighbor Report (RNR) element with a Target Beacon Transmission Time (TBTT) Information Field Type subfield set to a first predefined value and a TBTT Information Field Length subfield set to a second predefined value in a TBTT Information field corresponding to a reported AP on the auxiliary link.

6. The method of claim 5, wherein the TBTT Information field corresponding to the reported AP on the auxiliary link comprises at least one of a link identification (ID) subfield, a link disablement subfield, and an aggregation bandwidth subfield.

7. The method of claim 6, wherein the link disablement subfield indicates whether the auxiliary link is enabled or disabled such that:
responsive to the link disablement subfield indicating the auxiliary link enabled, the aggregated bandwidth is indicated in the TBTT Information field to indicate that the AP is operating with the aggregated bandwidth; and
responsive to the link disablement subfield indicating the auxiliary link disabled, the aggregated bandwidth subfield is reserved in the TBTT Information field to indicate that the AP is not operating with the aggregated bandwidth.

8. The method of claim 5, wherein a channel number of the auxiliary link is indicated in a Neighbor AP field corresponding to the reported AP on the auxiliary link in the RNR element.

9. The method of claim 1, wherein the performing of the aggregated-bandwidth operation comprises advertising, as a reporting AP affiliated with an AP multi-link device (MLD), the primary link and the auxiliary link of an aggregated-bandwidth capable neighbor AP, as a reported AP, affiliated with the AP MLD.

10. The method of claim 9, wherein the advertising comprises advertising the primary link with a Target Beacon Transmission Time (TBTT) Information Field Type subfield set to a first predefined value and a TBTT Information Field Length subfield set to a second predefined value in a Reduced Neighbor Report (RNR) element.

11. The method of claim 1, wherein the performing of the aggregated-bandwidth operation with one or more STAs comprises:
obtaining a transmission opportunity (TXOP);
transmitting a control frame to a first STA and a second STA of the one or more STAs with an indication to switch the second STA to the auxiliary link;
receiving a first control response frame from the first STA over the primary link and a second control response frame from the second STA over the auxiliary link; and
transmitting a downlink (DL) physical-layer protocol data unit (PPDU) or a trigger frame to the first STA over the primary link and to the second STA over the auxiliary link.

12. A method, comprising:
receiving, by a processor of a non-access point (non-AP) station (STA), a beacon frame or management frame indicating an aggregated-bandwidth capability of an access point (AP); and
performing, by the processor, an aggregated-bandwidth operation involving a primary link and an auxiliary link with the AP,
wherein an aggregated bandwidth of the primary link and the auxiliary link depends on a channel availability of each of the primary link and the auxiliary link.

13. The method of claim 12, wherein the performing of the aggregated-bandwidth operation comprises discovering the auxiliary link based on a Reduced Neighbor Report (RNR) element with a Target Beacon Transmission Time (TBTT) Information Field Type subfield set to a first predefined value and a TBTT Information Field Length subfield set to a second predefined value in a TBTT Information field.

14. The method of claim 13, wherein a channel number of the auxiliary link is indicated in a Neighbor AP field corresponding to the AP on the auxiliary link in the RNR element.

15. The method of claim 12, wherein the performing of the aggregated-bandwidth operation comprises indicating to the AP whether the STA is capable of dynamic channel switching within a specific bandwidth which is less than or equal to the aggregated bandwidth.

16. The method of claim 12, wherein, responsive to the non-AP STA being affiliated with a single-radio multi-link device, the performing of the aggregated-bandwidth operation comprises identifying an aggregated-bandwidth capable reporting AP by an aggregated-bandwidth capability indicated in an Ultra-High-Reliability (UHR) Operation element or UHR Capability element carried in the beacon frame or management frame.

17. The method of claim 16, wherein the performing of the aggregated-bandwidth operation further comprises identifying a link disablement status of the auxiliary link and the aggregated bandwidth of the reporting AP based on a Reduced Neighbor Report (RNR) element.

18. The method of claim 12, wherein, responsive to the non-AP STA being affiliated with a multi-radio multi-link device, the performing of the aggregated-bandwidth operation comprises identifying a reported AP which is aggregated-bandwidth capable based on a Reduced Neighbor Report (RNR) element carried in the beacon frame or management frame, which includes another neighbor AP with a Target Beacon Transmission Time (TBTT) Information Field Type subfield set to a first predefined value and a TBTT Information Field Length subfield set to a second predefined value with a same link identification (ID) of the reported AP.

19. The method of claim 18, wherein the performing of the aggregated-bandwidth operation further comprises identifying a link disablement status of the auxiliary link and the aggregated bandwidth of the reported AP based on the RNR element.

20. The method of claim 12, wherein the performing of the aggregated-bandwidth operation with the AP comprises:
receiving a control frame from the AP;
responsive to receiving the control frame, transmitting a control response frame to the AP over the primary link or, after switching to the auxiliary link, over the auxiliary link; and
receiving a downlink (DL) physical-layer protocol data unit (PPDU) or a trigger frame over the primary link or the auxiliary link.
